(19) United States
(12) Patent Application Publication
(10) Pub. No.: US 2020/0326058 A1
(43) Pub. Date: Oct. 15, 2020

(54) Spring Bolt Joining System for Light Fixtures

(71) Applicant: Nulite Lighting, Denver, CO (US)

(72) Inventors: Emily Stratton, Denver, CO (US); Jay Martin Almblad, Westminster, CO (US); Patrick Hersco, Denver, CO (US); Brian Beck, Denver, CO (US)

(73) Assignee: Nulite Lighting, Denver, CO (US)

(21) Appl. No.: 16/790,710

(22) Filed: Feb. 13, 2020

Related U.S. Application Data
(60) Provisional application No. 62/805,541, filed on Feb. 14, 2019.

(51) Int. Cl. F21V 21/005; F21S 2/00

(52) U.S. Cl. CPC F21V 21/005; F21Y 2115/10; F21S 2/005

(57) ABSTRACT

A joining system for light fixtures where one fixture attaches to the next without the need for tools or access to the interior of the fixture. The spring bolt joining system can be used with all styles of linear and non-linear fixtures. A few examples of the mounting styles that work with this joining system: suspended mounted fixtures, surface mounted fixtures, recessed mounted fixtures and wall mounted fixtures.

### RELATED APPLICATIONS

This application claims the benefit of U.S. Provisional application No. 62/805,541 titled “Spring Bolt Joining System for Light Fixtures” filed 14 Feb. 2019 which is incorporated herein by reference.

### BACKGROUND OF THE INVENTION

Current slot style lighting fixtures require access to the interior for joining one fixture to the next. Generally, this requires the removal of the lens and/or LED boards to gain access to make a mechanical connection between two fixtures. Disassembly and reassembly of the components is time consuming and introduces the risk of incorrect re-installation of the components, or damaging components and wiring.

There is a need for a joining system that doesn't require access to the interior of the fixture and is tool free for ease of install.

### SUMMARY OF THE INVENTION

A joining system for light fixtures where one fixture attaches to the next without the need for tools or access to the interior of the fixture. The system is comprised of a light fixture housing with an endplate holding a bolt with a flange on one end and a spring on the interior held in compression with a nut. The light fixture endplate with bolt also has alignment holes and guiding slots. A retaining clip holds the flange on the bolt off the face of the mating light fixture. The mated light fixture has alignment pins. The alignment pins are used to release the retaining clip allowing the bolt to release with enough compression to hold the two fixtures together. The pins are also used to align the two fixtures once the retaining clip is released after the two fixtures lock together.

An alternative embodiment of the joining system is comprised of a light fixture housing with an endplate holding a bolt with a flange with a spring on the interior held in compression with a nut. The bolt has a rib feature on the surface that interfaces with the mating fixture. The light fixture endplate with bolt also has alignment holes and guiding slots. A retaining clip holds the bolt off the face of the mating light fixture. Alternatives to activate joining system are protrusions from the mated fixture, magnets, rotation of housing, vertical or horizontal motion, cam, hook, latch or snap features. The mated light fixture has alignment pins with a slot that engages and locks in with the bolt. The alignment pins are used to release the retaining clip allowing the flange to engage with the interior surface of a second lighting fixture with enough compression to join and hold the two fixtures together. The pins are also used to align the two fixtures once the retaining clip is released after the two fixtures lock together. The bolt with rib and the endplate with slot engages after retaining clip releases.

The joining system can be used with all styles of linear and non-linear fixtures. A few examples of the mounting styles that work with this joining system: suspended mounted fixtures, surface mounted fixtures, recessed mounted fixtures and wall mounted fixtures.

### BRIEF DESCRIPTION OF DRAWINGS

FIG. 1. Faces of a mated and mating fixture

FIG. 2. Internal spring mechanism

FIG. 3. Joint being actuated

FIG. 4. Joint being actuated end view

FIG. 5. An actuated joint

FIG. 6. Flared bolt

FIG. 7. Bolt rib

FIG. 8. Endplate slot

FIG. 9. Rib and slot engagement after joint actuation

### DETAILED DESCRIPTION OF THE INVENTION

The present disclosure relates generally to lighting solutions including LED light fixtures. In one embodiment, a light fixture includes more than one LED lighting fixture joined to another by a joining system comprising of an endplate holding a bolt with a spring on the interior held in compression with a nut. The joining system enables joining of fixtures by aligning the joining system and sliding movement joining two fixtures without the need to access the interior of the fixture.

The joining system comprises a fixture with an endplate holding a bolt with a spring on the interior held in compression with a nut. A retaining clip keeps a flange on the bolt off the face of the mating fixture. The mated fixture has alignment pins that line up with slots in the mating fixtures face. When the pins of the mated fixture are lined up with the slots of the mating fixture, mating fixture can be lifted into position where the pins force the retaining clip off of the bolt allowing the spring to activate the bolt which releases with enough compression to hold the two fixtures together. Once in final position the pins come to rest in alignment holes holding the two fixtures together in correct alignment.

One embodiment of the claims is described in the drawings.

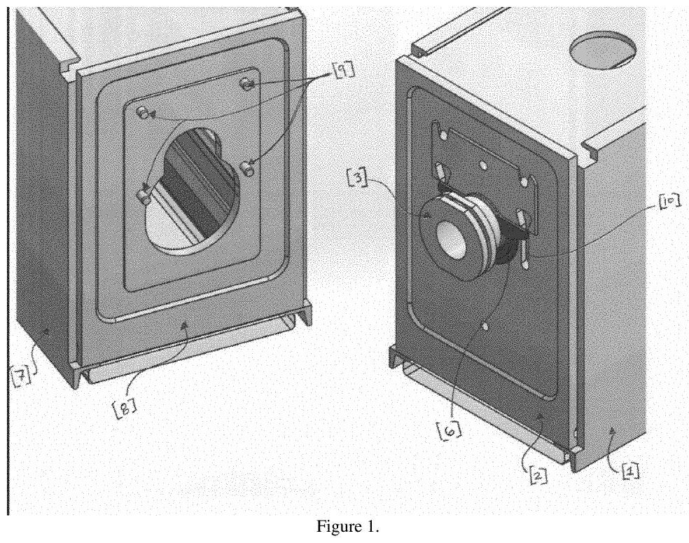

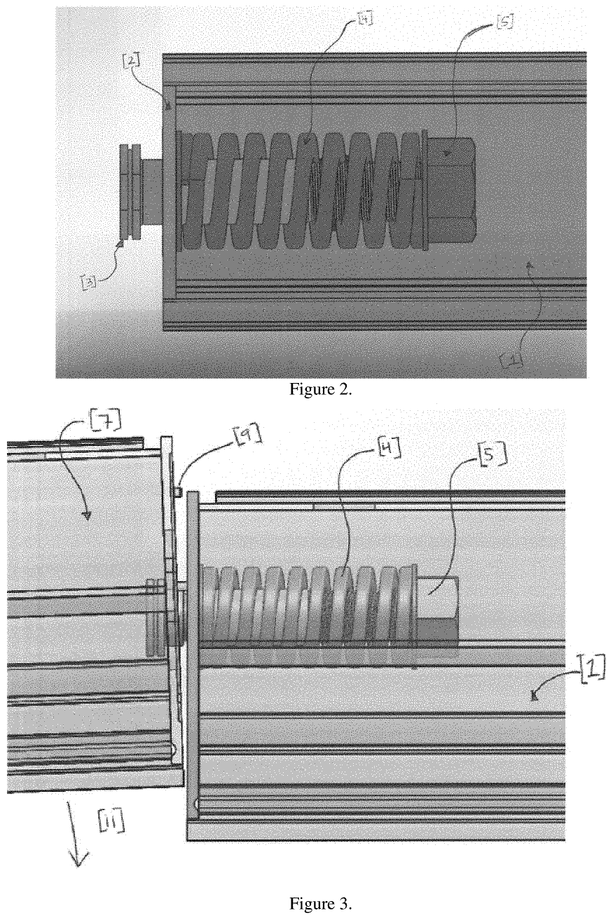

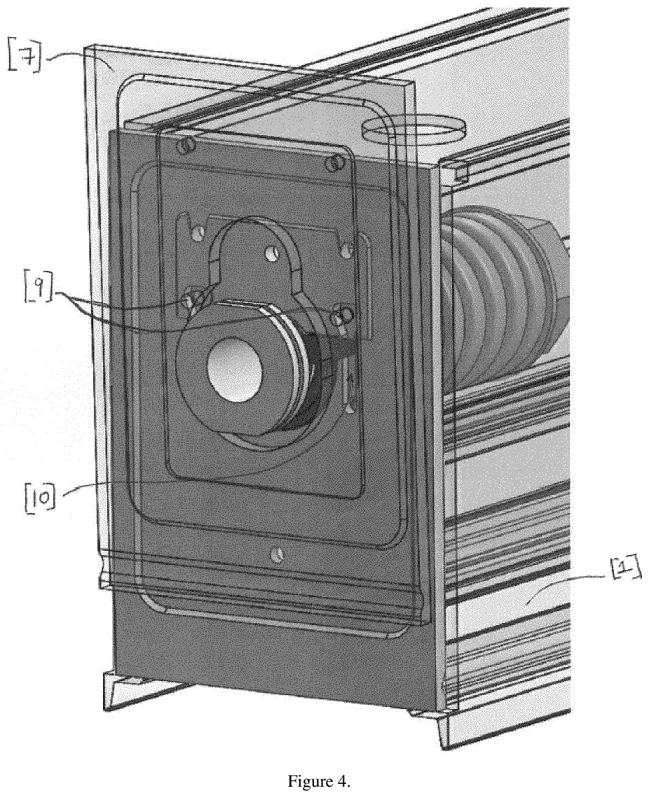

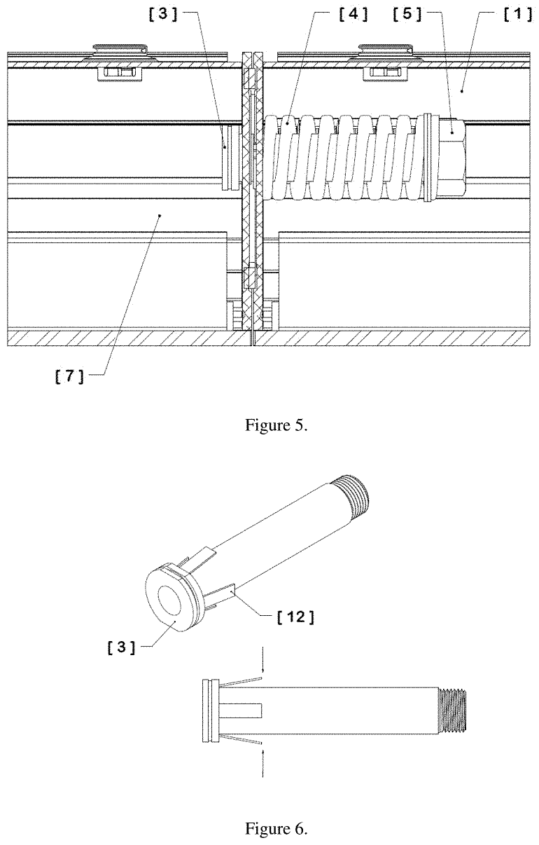

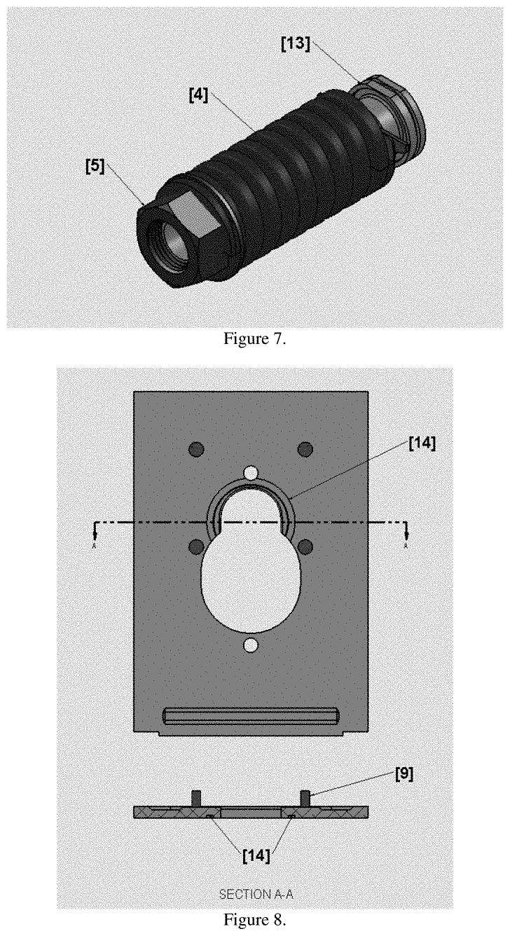

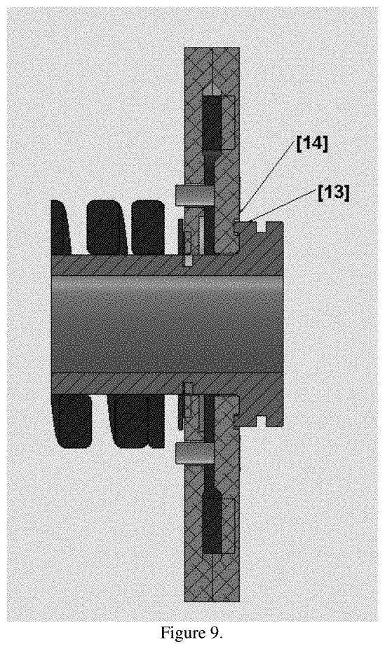

The figures show a joining system that comprises of a mating fixture [1] with an endplate [2] holding a bolt with a flange [3] (FIG. 1) with a spring [4] on the interior held in compression with a nut [5] (FIG. 2). A retaining clip [6] keeps the bolt flange off the face of the mating fixture. The mated fixture [7] to be joined to fixture 1, has an endplate [8] with alignment pins [9] that line up with slots in the mating fixture [10] that force the retaining clip [6] (FIG. 4) off the bolt [3] with a stroke [11] (FIG. 3) allowing the bolt flange to release with enough compression to hold the two fixtures together (FIG. 5). In another embodiment, the spring used for fixture to fixture retention may be integrated into the bolt design [FIG. 6]. The wings would provide tension on the endplate and act as the compression mechanism for the joining system [12] (FIG. 6). In another embodiment, the spring loaded bolt assembly would have a flanged bolt that has a circular rib [13] located on the flange face used for mating to another fixture (FIG. 7). The endplate on the mating fixture would have a slotted feature [14] that corresponds to the rib feature on the flanged bolt (FIG. 8). Completed actuation of the joining assembly, the rib on the bolt [13] locked into the slot on the endplate [14] (FIG. 9) creating a more dynamic joining and locking method for two fixtures.

In one embodiment, a joining system is described with a spring bolt with a flange holding two light fixtures together. In one embodiment, a joining system is described with magnets holding two light fixtures together. One embodiment of the joining system may use a wire tensioning system instead of a spring where a wire is wound around a rotating shaft with a knob or lever on the surface of the lighting fixture that increases or decreases tension on the mating surfaces and firmly holding fixtures together. In one embodiment protrusions from the mated fixture actuate the joining system. In one embodiment magnets actuate the joining system. In one embodiment the joining system is actuated with a vertical stroke. In another embodiment the joining system is actuated with a rotational force. In one embodiment the mating faces are flush. In another embodiment the mating surfaces are concave. In one embodiment the mating surfaces are convex. In one embodiment the mating surfaces are both concave and convex or flat and convex or flat and concave.

In one embodiment the actuation occurs when geometry on the bolt is activated by the two fixtures coming together. In another embodiment geometry on the end features actuates the bolt. In one embodiment the bolt has a flare feature that snaps into the mated fixture. The actuating stroke can be in the vertical plane, horizontal plane or a rotational force.

In one embodiment, a joining system is described comprising a light fixture with an endplate holding a bolt bearing a flange with a spring on the interior held in compression with a nut. A retaining clip keeps the flange off the face of the mating fixture. The mated fixture has alignment pins that line up with slots in the mating fixtures surface that guide the retaining clip off of the bolt during the stroke, allowing the bolt to release with enough compression to hold the two fixtures together once activated in the correct orientation.

In one embodiment, a joining system is described comprising a light fixture with an endplate holding a bolt bearing a flange on its outer surface with a spring on the interior held in compression with a nut with a retaining clip to keep the flange off the face of the mating fixture and a second light fixture bearing a receiving orifice where the surface of a fixture bears alignment pins that line up with slots in the mating fixtures surface that guide the retaining clip off of the flange engaging and joining the two fixtures.

In one embodiment the mated light fixture has alignment pins with a slot that engages and locks in with the bolt. The alignment pins are used to release the retaining clip allowing the bolt to release with enough compression to hold the two fixtures together. In other embodiments other alignment means may be employed such as grooves, ridges and other complimenting concave and convex mating shapes on the mating surfaces of the two fixtures.

The joining system is for fixtures which are linear suspended fixtures, surface mounted fixtures, recessed fixtures, fixtures mounted to the wall and the like.

The joining system components can be made from various materials that maintain their shape under conditions for which the system is purposed. Materials employed may include metals such as aluminum, magnesium alloys, steel and the like; synthetic polymers such as polyacetals, polycarbonates, nylons, polyesters, acrylonitrile butadiene styrene (ABS) materials, polypropylene, HDPE, polyurethanes and the like; natural polymers such as wood, silk, cotton, etc. Other materials such as carbon fiber materials, composites, glass, ceramics or plastics and like materials may be used to fabricate the components of the system.

The system components may be fabricated by various processes known in the art to make components including extrusion, injection molding, stamping, cold forming and like industrial methods and other methods such as 3D printing, hand crafting and the like.

What is claimed is:

1. A device for joining two light fixtures comprising:
A light fixture with an endplate holding a bolt bearing a flange on its outer joining surface with a spring on the interior held in compression with a nut, a retaining clip keeping the flange off the face of the mating fixture joined to a second fixture having alignment pins which line up the fixture surfaces, guiding the retaining clip off and activating and engaging the flange during the joining stroke, firmly joining and aligning the two fixtures together.

2. The lighting fixture joining system of claim 1 where, the fixtures are linear suspended fixtures, surface mounted fixtures, recessed fixtures, or mounted on the wall.

3. The joining system of claim 1 where, the components are made from various materials that maintain their shape under ambient conditions for which the system is purposed.

4. The joining system of claim 1 where, materials employed for fabrication of the components are selected metals such as aluminum, magnesium alloys, steel and the like; synthetic polymers such as polyacetals, polycarbonates, nylons, polyesters, acrylonitrile butadiene styrene (ABS) materials, polypropylene, HDPE, polyurethanes and the like; natural polymers such as wood, silk, cotton, etc. Other materials such as carbon fiber materials, composites, glass, ceramics or plastics and the like materials may be used to fabricate the components of the system.

5. The joining system of claim 1 where, the mating surfaces are flat.

6. The joining system of claim 1 where, the mating surfaced are both concave and convex.

7. The joining system of claim 1 where, the mating surfaces are convex

8. The joining system of claim 1 where, the actuating mechanism works using a vertical or horizontal stroke.

9. The joining system of claim 1 where, the actuating mechanism works using a rotational twisting motion.

10. The joining system of claim 1 where the spring is integrated into the bolt design.

11. The joining system of claim 1 where the system is joined with a flared feature on the bolt.

12. The joining system of claim 1 where the system is joined using a bolt with a fib feature and an endplate with a slot feature.

13. A device for joining two light fixtures comprising:
A light fixture with an endplate holding a bolt bearing a flange on its outer surface with a spring on the interior held in compression with a nut with a retaining clip to keep the flange off the face of the mating fixture and a second light fixture bearing a receiving orifice where the surface of a fixture bears alignment pins that line up with slots in the mating fixtures surface that guide the retaining clip off of the flange engaging and joining the two fixtures.

14. A device of claim 1 where,
the fixtures are joined by inserting and sliding the flanged connector into the orifice of a receiving light fixture engaging the spring bolt flange firmly with the joining surface.

15. A device of claim 1 where,
pins are used for alignment and reinforcement of the union between the light fixtures.

16. The joining system of claim 1 where, the actuating mechanism works using a vertical or horizontal stroke.

17. The joining system of claim 1 where, the actuating mechanism works using a rotational twisting motion.

18. The joining system of claim 1 where the spring is integrated into the bolt design.

19. The joining system of claim 1 where the system is joined with a flared feature on the bolt.

20. The joining system of claim 1 where the system is joined using a bolt with a fib feature and an endplate with a slot feature.
